(19) United States
(12) Patent Application Publication
(10) Pub. No.: US 2026/0171328 A1
(43) Pub. Date: Jun. 18, 2026

(54) LITHIUM ION CAPACITOR FOR ENERGY HARVESTING

(71) Applicant: MATERIALS INNOVATION TSUKUBA INCORPORATED, Ibaraki (JP)

(72) Inventors: Hang YIN, Ibaraki (JP); Kun ZHANG, Ibaraki (JP); Yu MATSUMOTO, Ibaraki (JP); Yukinori HATO, Ibaraki (JP)

(21) Appl. No.: 18/710,618

(22) PCT Filed: Nov. 17, 2022
(86) PCT No.: PCT/JP2022/042765

§ 371 Date: May 16, 2024

(30) Foreign Application Priority Data
Nov. 17, 2021 (JP) 2021-186745

(51) Int. Cl. H01G 11/50; H01G 11/36; H01G 11/60; H01G 11/62

(52) U.S. Cl. CPC H01G 11/50; H01G 11/36

(57) ABSTRACT

To provide a lithium ion capacitor for energy harvesting, which has minute self-discharge and whose capacitance almost does not decrease even after repeated charging and discharging. A lithium ion capacitor for energy harvesting, comprising a positive electrode containing a positive electrode active material that reversibly adsorbs and desorbs lithium ions and anions; a negative electrode containing a negative electrode active material that reversibly occludes and releases lithium ions; and an electrolyte containing a lithium salt and an aprotic organic solvent and in contact with the positive electrode and the negative electrode; wherein lithium ions are occluded in advance in the negative electrode, and the mass of the negative electrode active material contained in the negative electrode is at least twice the mass of the positive electrode active material contained in the positive electrode.

### CROSS-REFERENCE TO RELATED APPLICATIONS

The present application is a National Phase of International Application No. PCT/JP2022/042765 filed Nov. 17, 2022, which claims the benefit of priority from the prior Japanese patent application No. 2021-186745 filed on Nov. 17, 2021.

### TECHNICAL FIELD

The present invention relates to a lithium ion capacitor for energy harvesting used as an electricity storage device for energy harvesting.

### BACKGROUND ART

Energy harvesting is a power generation technology that converts small amounts of familiar energy such as light, heat, vibration, and wind into electricity, and is also referred to as power harvesting. Since these energy harvesting methods yield only a small amount of electricity and the amount of power generated tends to fluctuate, they are being put into practical use by combining them with electricity storage devices such as lithium ion secondary batteries and electric double layer capacitors.

On the other hand, conventional electricity storage devices for energy harvesting have problems such as charging efficiency and deterioration, and in recent years, the application of lithium ion capacitors has been considered. A lithium ion capacitor is a hybrid capacitor that has a structure in which a negative electrode of a lithium ion secondary battery and a positive electrode of an electric double layer capacitor are combined, and the principles of the positive electrode and negative electrode are different (see, for example, Patent Literatures 1 and 2).

Patent Literature 1 describes an organic electrolyte capacitor in which a positive electrode active material is an active material that can reversibly support lithium ions and anions, a negative electrode active material is an active material that can reversibly support lithium ions, the capacitance per unit mass of the negative electrode active material is three times or more the capacitance per unit mass of the positive electrode active material, and the mass of the positive electrode active material is greater than the mass of the negative electrode active material, and lithium ions are preliminarily intercalated into the negative electrode.

In addition, in a lithium ion capacitor described in Patent Literature 2, a negative electrode are pre-doped with lithium ions so that the potential of the positive electrode after short-circuiting the positive electrode and negative electrode is 2.0 V or less; and if the capacitance per unit mass of the positive electrode is expressed as C₊(F/g), the mass of the positive electrode active material is expressed as W₊(g), the capacitance per unit mass of the negative electrode is expressed as C₋(F/g), and the mass of the negative electrode active material is expressed as W₋(g), then, the value of (C₋×W₋)/(C₊×W₊) is 5 or more, for the purpose of high capacity and long life.

### CITATION LIST

### Patent Literature

Patent Literature 1: International Publication WO 2003/003395
Patent Literature 2: Japanese Patent Application Publication No. 2007-158273

### SUMMARY OF INVENTION

### Technical Problem

As mentioned above, since the amount of power generated by energy harvesting is minute, the electricity storage device used in combination is required to efficiently charge a minute current. Further, since a large capacitance requires a long time to charge, it is preferable that the capacitance of the electricity storage device is small, and it is necessary to suppress leakage current, that is, self-discharge to a sufficiently low level. Furthermore, since electricity storage devices for energy harvesting frequently switch between charging and discharging as the amount of power generation changes, they are also required to maintain capacity semi-permanently regardless of the frequency of charging and discharging.

However, the above-mentioned conventional lithium ion capacitor does not have sufficient charge retention ability to suppress self-discharge over time as an electricity storage device for energy harvesting, and cannot satisfy it other requirements.

Therefore, an object of the present invention is to provide a lithium ion capacitor for energy harvesting that has little self-discharge and whose capacitance almost does not easily decrease even after repeated charging and discharging.

### Solution to Problem

The lithium ion capacitor for energy harvesting according to the present invention comprises a positive electrode containing a positive electrode active material that reversibly adsorbs and desorbs lithium ions and anions; a negative electrode containing a negative electrode active material that reversibly occludes and releases lithium ions; and an electrolyte containing a lithium salt and an aprotic organic solvent and in contact with the positive electrode and the negative electrode; wherein lithium ions are pre-doped in the negative electrode, and the mass of the negative electrode active material contained in the negative electrode is more than twice the mass of the positive electrode active material contained in the positive electrode.

For example, a composite of graphene and carbon nano-tubes can be used as the positive electrode active material.

The positive electrode active material has, for example, a median diameter (D50) of 5 μm or less.

On the other hand, metallic lithium may be arranged as a supply source of lithium ions to the negative electrode.

The lithium ion capacitor for energy harvesting of the present invention may be encapsulated in an exterior body made of a metal foil laminate film, or may be encapsulated in a coin-shaped exterior body.

### Advantageous Effects

According to the present invention, it is possible to realize a lithium ion capacitor for energy harvesting that suppresses self-discharge, has a capacitance that almost does not decrease even with frequent charging and discharging, and has a semi-permanent lifespan.

### BRIEF EXPLANATION OF DRAWINGS

FIG. 1 is a schematic diagram showing a configuration example of a lithium ion capacitor according to an embodiment of the present invention.

FIG. 2 is a conceptual diagram showing the principle of charging and discharging a lithium ion capacitor.

FIG. 3 is a diagram showing an equivalent circuit of a lithium ion capacitor.

### DESCRIPTION OF EMBODIMENTS

Hereinafter, embodiments for carrying out the present invention will be described in detail with reference to the accompanying drawings. Note that the present invention is not limited to the embodiments described below.

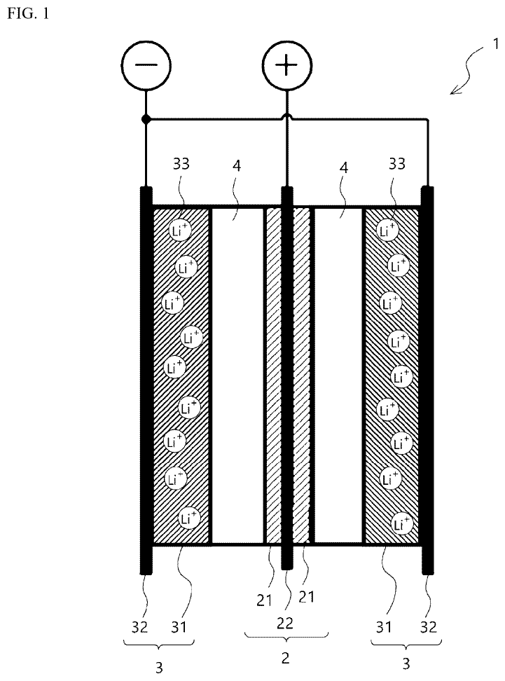

FIG. 1 is a schematic diagram showing a configuration example of a lithium ion capacitor according to an embodiment of the present invention. As shown in FIG. 1, a lithium ion capacitor 1 according to the present embodiment has a positive electrode 2 containing a positive electrode active material 21, a negative electrode 3 containing a negative electrode active material 31, and an electrolyte 4 containing a lithium salt and an aprotic organic solvent, and the negative electrode 3 is pre-doped with lithium ions 33. In the lithium ion capacitor 1 of this embodiment, the mass of the negative electrode active material 31 contained in the negative electrode 3 is at least twice the mass of the positive electrode active material 21 contained in the positive electrode 2.

### [Positive Electrode 2]

The positive electrode 2 can be formed by coating a slurry containing the positive electrode active material 21 to the surface of a positive electrode current collector 22 made of a metal material such as aluminum or stainless steel, and then drying the slurry. Here, the form of the positive electrode current collector 22 is not particularly limited, and foils, sheets, etc. made of the above-mentioned metal materials can be used, and materials having a through hole such as expanded metal, punched metal, net, foam, etc. are preferable.

On the other hand, the positive electrode active material 21 may be any materials as long as it can reversibly adsorbs and desorbs lithium ions and anions, and for example, conventionally used materials such as activated carbon, conductive polymers, and polyacene-based materials can be used. Further, in the lithium ion capacitor 1 of this embodiment, a composite of graphene and carbon nano-tubes (CNT) may be used as the positive electrode active material 21. For example, if a graphene/CNT composite having plate-like crystals of Co(OH)₂ crystal-grown on the surface described in JP-A No. 2015-20920 and International Publication WO 2015/129820 is used as the positive electrode active material 21, then, electrons and ions can be efficiently involved in redox reactions, and the cycle life of the lithium ion capacitor 1 can be extended.

In a general lithium ion capacitor 1, the mass of the positive electrode active material 21 is made larger than the mass of the negative electrode active material 31 in order to increase the capacity, but in the lithium ion capacitor 1 of this embodiment, the mass of the positive electrode active material 21 is made smaller than that of the negative electrode active material 31 since it is for energy harvesting and since a smaller capacitance is preferable.

Specifically, the mass of the negative electrode active material 31 contained in the negative electrode 3 is more than twice the mass of the positive electrode active material 21 contained in the positive electrode 2, that is, the mass of the positive electrode active material is set to ½ or less of the mass of the negative electrode active material 31. As a result, a lithium ion capacitor with a small capacity and a fast charging speed suitable for energy harvesting applications can be obtained. Note that the mass of the positive electrode active material 21 is preferably ⅓ or less, more preferably ⅕ or less, and still more preferably 1/10 or less of the mass of the negative electrode active material 31.

Further, the positive electrode active material 31 preferably has a median diameter (D50) of 5 μm or less, more preferably 3 μm or less. By using such a material with a fine particle size, a thin electrode (positive electrode 2) with a thickness of 10 μm or less can be formed.

### [Negative Electrode 3]

The negative electrode 3 can be formed by coating a slurry containing the negative electrode active material 31 onto the surface of a negative electrode current collector 32 made of a metal material such as copper, aluminum, stainless steel, or nickel, and then drying the slurry. The form of the negative electrode current collector 32 is not particularly limited either, and for example, a foil or sheet made of the above-mentioned metal material can be used, and materials having a through hole such as expanded metal, punched metal, net, foam, etc. are preferable.

The negative electrode active material 31 may be any material that can reversibly occlude and release lithium ions, and for example, graphite, various carbon materials, polyacene-based materials, tin oxides, silicon oxides, and the like can be used. As described above, in the lithium ion capacitor 1 of this embodiment, the mass of the negative electrode active material 31 contained in the negative electrode 3 is more than twice the mass of the positive electrode active material 21 contained in the positive electrode 2, and it is preferably 3 times or more, more preferably 5 times or more, and even more preferably 10 times or more.

Further, the particle size of the negative electrode active material 31 is not particularly limited, but it is preferable to use a material having a relatively large particle size in order to have a larger mass than the positive electrode active material 21. By using a material with a large median diameter for the negative electrode active material 31, it is possible to suppress side reactions at the interface of active material and electrolyte.

In the lithium ion capacitor 1 of this embodiment, lithium ions 33 are pre-doped in advance in the negative electrode 3 by a chemical method or an electrochemical method. Examples of the method for pre-doping the negative electrode 3 with lithium ions 33 include ex situ electrochemical method (EEC method) and in situ electrochemical method (IEC method).

On the other hand, the lithium ion capacitor 1 of this embodiment does not require a large capacitance, and in order to make the mass of the negative electrode active material 31 larger than the positive electrode active material 21, the number of the negative electrodes 3 facing the positive electrode 2 is one or two, and thus, a lithium attachment method in which metallic lithium is attached to the negative electrode 3 is suitable.

When the negative electrode 3 is pre-doped with lithium ions 33 by the lithium attachment method, for example, foil-shaped metallic lithium may be attached on the negative electrode 3 or at a position electrically connected to the negative electrode 3. By arranging metallic lithium as a supply source of lithium ions 33 to the negative electrode 3 in this manner, lithium ions 33 can be easily pre-doped. At this time, it is preferable that the negative electrode current collector 32 is formed of expanded metal or the like to obtain a configuration with through holes. This allows the lithium ions 33 to move into the negative electrode active material 31 through the through holes of the negative electrode current collector 32.

Further, the thickness of the foil-shaped metallic lithium used in the lithium attaching method may be any value as long as it falls within a range in which lithium does not residue in the pre-doping process, and is preferably less than ½ of the thickness of the negative electrode active material 31, for example. Furthermore, in the lithium attaching method, a lithium powder can be used instead of lithium foil, but foil is more suitable from the viewpoint of ease of handling during the production process.

### [Electrolyte 4]

The electrolyte 4 contains a lithium salt and an aprotic organic solvent, and is in contact with the positive electrode 2 and the negative electrode 3. For the aprotic organic solvent constituting the electrolyte 4, for example, ethylene carbonate, propylene carbonate, dimethyl carbonate, γ-butyrolactone, acetonitrile, dimethoxyethane, tetrahydrofuran, dioxolane, methylene chloride, and sulfolane can be used, and these may be used alone or in combination of two or more. Further, the electrolyte constituting the electrolyte 4 may be any electrolyte as long as it generates lithium ions, and for example, lithium salts such as LiI, LiClO₄, LiAsF₆, LiBF₄, and LiPF₆ can be used.

### [Encapsulation]

The lithium ion capacitor 1 of this embodiment may be encapsulated in an exterior body made of a metal foil laminate film, or may be encapsulated in a coin-shaped exterior body. For example, by constructing the exterior body with an aluminum laminate film, the entire lithium ion capacitor 1 can be made thinner and lighter. On the other hand, the coin-shaped exterior body has a track record of application to lithium ion capacitors that are pre-doped using the lithium attaching method, making it possible to realize lithium ion capacitors that are low cost, have excellent mass productivity, and have excellent quality stability.

### [Working Principle]

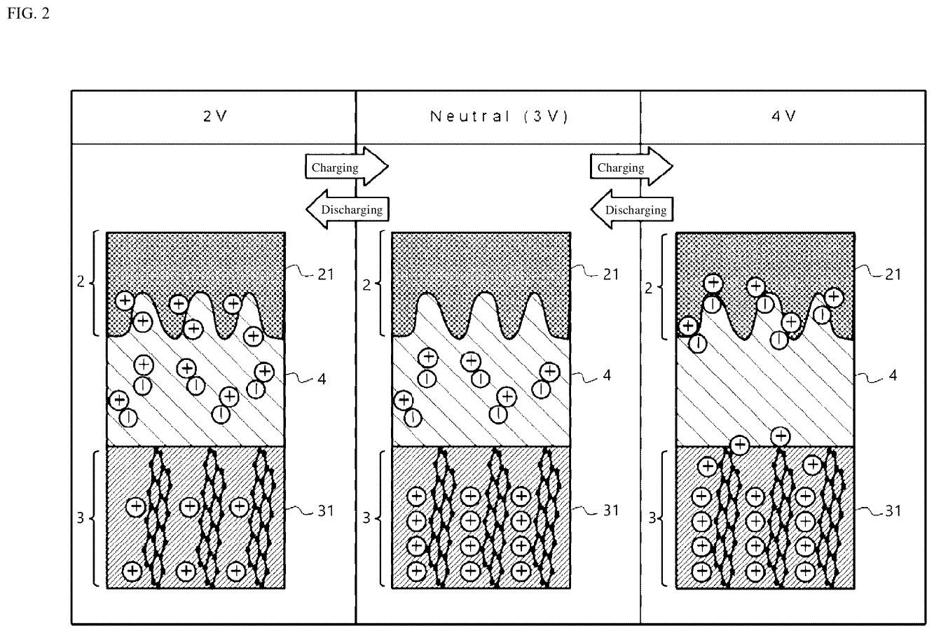

Next, the working of the lithium ion capacitor 1 of this embodiment will be described. FIG. 2 is a conceptual diagram showing the principle of charging and discharging a lithium ion capacitor. As shown in FIG. 2, in the lithium ion capacitor 1 of this embodiment, in the initial state (Neutral), pre-doped lithium ions 33 are supported on the negative electrode active material 31, and the potential of the negative electrode active material 31 is about 3V. The cell voltage at this time is about 3V, which is the difference of potential between positive and negative electrodes.

When this lithium ion capacitor 1 is charged from the initial state (Neutral), anions (−) are adsorbed to the positive electrode active material 21 and the positive electrode 2 is positively charged, and lithium ions, which are cations (+), are intercalated to the negative electrode active material 31, and the cell voltage increases to, for example, 4 V. On the other hand, when discharging from the initial state (Neutral), cations (+) are adsorbed to the positive electrode active material 21, lithium ions in the negative electrode active material 31 released, and the cell voltage decreases to, for example, 2 V.

In the lithium ion capacitor 1 of this embodiment, the positive electrode 2 behaves like a capacitor that holds charge by physically adsorbing lithium ions without any electrochemical reaction. Since the phenomenon that occurs in the positive electrode 2 is the adsorption/desorption of ions onto/from the surface of the active material, the amount of charge that can be held, that is, the chargeable capacity is determined by the surface area of the active material.

On the other hand, the negative electrode 3 behaves like a battery in which lithium ions are supported on the active material with an electrochemical reaction through charging and discharging, and during charging, lithium ions in the electrolyte are supported in the active material with an electrochemical reaction, while during discharging, lithium ions are released from the active material into the electrolyte, on the contrary. The phenomenon that occurs in the negative electrode 3 during charging and discharging is an electrochemical reaction between lithium ions and the active material, and the chargeable capacity is determined by the volume or mass of the negative electrode active material.

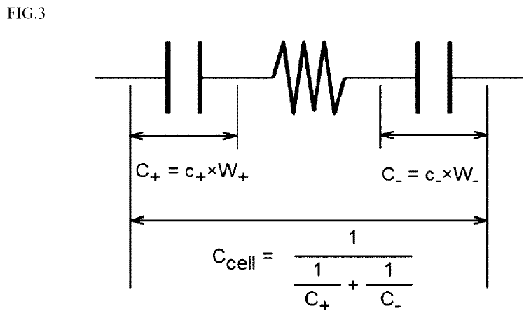

FIG. 3 is a diagram showing an equivalent circuit of a lithium ion capacitor. As shown in FIG. 3, the capacitance C_{cell} of the entire lithium ion capacitor is expressed by the following mathematical formula 1 as a series connection of the capacitance C₊ of the positive electrode 2 and the capacitance C₋ of the negative electrode.

$$1 / {C}_{cell} = 1 / {C}_{+} + 1 / {C}_{-} \qquad [ mathematical formula 1 ]$$

Here, the capacitance C₊ of the positive electrode 2 and the capacitance C₋ of the negative electrode 3 are expressed by the following mathematical formulae 2 and 3, respectively, from the capacitance c₊ and capacitance c₋ per unit mass, and the mass W₊ of the positive electrode active material 21 and the mass W₋ of the negative electrode active material 31.

$${C}_{+} = {c}_{+} \times {W}_{+} \qquad [ mathematical formula 2 ]$$

$${C}_{-} = {c}_{-} \times {W}_{-} \qquad [ mathematical formula 3 ]$$

If the ratio of the capacitances in the mathematical formulae 2 and 3 above is defined as K, it is expressed by the following mathematical formula 4.

$$K = {C}_{-} / {C}_{+} = ( {c}_{-} \times {W}_{-} ) / ( {c}_{+} \times {W}_{+} ) \qquad [ mathematical formula 4 ]$$

Next, the capacity retention rate r is introduced as a parameter representing the lifespan. The capacity retention rate r can be defined as the ratio of the initial capacitance C_{cell} to the capacitance C′_{cell} of the cell after elapsing 2000 hours, as shown in the following mathematical formula 5.

$$r = {C}_{c e l l}^{′} / {C}_{cell} \qquad [ mathematical formula 5 ]$$

Furthermore, the capacity retention rate r₊ of the positive electrode 2 and the capacity retention rate r₋ of the negative electrode 3 are introduced. In that case, for example, a definition similar to the mathematical formula 5 above can be used, but in the case of a lithium ion capacitor, the negative electrode 3 behaves similarly to a battery, and the positive electrode 2 behaves similarly to a capacitor, so the capacity retention rate of the positive electrode 2 can be ignored as r₊=1.

Therefore, the initial capacitance C_{cell} and the capacitance C′_{cell} after elapsing a certain period of time can be expressed as shown in the following mathematical formulae 6 and 7, respectively.

$$1 / {C}_{c e l l} = 1 / {C}_{+} + 1 / {C}_{-} = K / {C}_{-} + 1 / {C}_{-} \qquad [ mathematical formula 6 ]$$

$$1 / {C}_{cell}^{′} = 1 / {rC}_{c e l l} = K / {C}_{-} + 1 / γ - {C}_{-} \qquad [ mathematical formula 7 ]$$

When the capacity retention rate r is determined from the mathematical formulae 6 and 7 above, it is expressed by the following mathematical formula 8.

$$r = ( K + 1 ) / ( K + 1 / {r}_{-} ) \qquad [ mathematical formula 8 ]$$

Here, assuming that the life span required for an electricity storage device used in combination with energy harvesting is the period during which the capacity retention rate r>0.98 is satisfied, the value required for the capacitance ratio K is as follows.

When the capacity retention rate of the negative electrode is r=0.5, then K>48

When the capacity retention rate of the negative electrode is r=0.1, then K>440

As described above, in the lithium ion capacitor of the present embodiment, the numerical range is completely different from “5≤(C₋×W₋)/(C₊×W₊)≤22.8” adopted for longer life span in the conventional lithium ion capacitor described in Patent Literature 2. That is, an electricity storage device used in combination with energy harvesting, such as the lithium ion capacitor of this embodiment, needs to be considered with a different concept from that of conventional lithium ion capacitors.

In practical terms, the capacitance per unit mass of the positive electrode 2 is 70 to 150 F/g, while that of the negative electrode 3 is 4000 F/g, and therefore, the inventors determined that the mass of the negative electrode active material 31 is set to be more than twice the mass of the positive electrode active material 21, for solving the problem to be solved by the present invention. This has a technical idea opposite to that of the conventional lithium ion capacitors described in Patent Literature 1 and Patent Literature 2.

As detailed above, in the lithium ion capacitor of the present embodiment, the negative electrode is pre-doped with lithium ions, and the mass of the negative electrode active material contained in the negative electrode is more than twice the mass of the positive electrode active material contained in the positive electrode, and the capacitance of the lithium ion capacitor is 20 mF or less, and therefore, self-discharge is suppressed, the capacitance almost does not decrease even with highly frequent charging and discharging, and a semi-permanent life span can be achieved.

### EXAMPLES

Hereinafter, the effects of the present invention will be specifically described using examples and comparative examples of the present invention. In the examples, lithium ion capacitors Nos. 1 to 13 were prepared and their performance was evaluated according to methods and conditions shown below.

### Example 1

### (1) Preparation of Positive Electrode

A slurry was prepared by blending a composition of 87 parts by mass of activated carbon powder, 5 parts by mass of acetylene black powder, 4 parts by mass of acrylic binder, 4 parts by mass of carboxymethyl cellulose, and 210 parts by mass of water, and thoroughly mixing them. The activated carbon powder used here had a specific surface area of 2168 m²/g and a median diameter (D50) of 1.4 μm.

An aluminum throughout foil with a thickness of 31 μm was used as the positive electrode current collector, and the prepared slurry was coated onto one side of the positive electrode current collector using a roll coater to form a positive electrode active material layer, followed by vacuum drying. The thickness of the positive electrode active material layer formed on one side of the positive electrode current collector was 12 μm, and the total thickness of the positive electrode including the thickness of the positive electrode current collector was 43 μm. At this time, the mass of the positive electrode active material was 0.41 g.

### (2) Preparation of Negative Electrode

A slurry was prepared by blending a composition of 88 parts by mass of carbonaceous electrode material (hard carbon) powder, 5 parts by mass of acetylene black powder, 3 parts by mass of styrene-butadiene rubber binder, 4 parts by mass of carboxymethyl cellulose, and 210 parts by mass of water, and thoroughly mixing them. The carbonaceous electrode material (hard carbon) used here had a specific surface area of less than 30 m²/g and a median diameter (D50) of 1.5±0.5 μm.

A copper foil with a thickness of 21 μm was used as the negative electrode current collector, and the prepared slurry was coated onto one side of the negative electrode current collector using a roll coater to form a negative electrode active material layer, followed by vacuum drying. The thickness of the negative electrode active material layer formed on one side of the negative electrode current collector was 101 μm, and the total thickness of the negative electrode including the thickness of the negative electrode current collector was 122 μm. At this time, the mass of the negative electrode active material was 8.76 g, and the mass ratio to the positive electrode active material was 21.4.

### (3) Measurement of Capacitance Per Unit Mass of Positive Electrode Active Material

Next, a laminate cell for evaluation was prepared and its capacitance was measured. Specifically, two evaluation electrodes with a size of 3.0 cm×3.0 cm were cut out from the positive electrode prepared by the method described above, and terminals were ultrasonically fused to each of these two evaluation electrodes, and then, these were laminated with a cellulose separator having a thickness of 25 μm sandwiched therebetween.

Two evaluation electrodes laminated with a separator interposed therebetween were housed in an exterior body made of a laminated film of polypropylene, aluminum, and nylon, and then an electrolyte was injected into the exterior body. The injected electrolyte is one prepared by dissolving lithium hexafluorophosphate (LiPF₆) to a concentration of 1 mol/L into a solvent that is a mixture of ethylene carbonate (EC) and diethyl carbonate (DEC) at a volume ratio of 1:1. After injecting the electrolyte, the exterior body was sealed by heat-sealing with the ends of the electrode terminals pulled out, to obtain a laminate cell for evaluation.

The capacitance of the assembled laminate cell for evaluation was measured in a potential range of 0 to 2.7 V at room temperature. The capacitance C (F/g) per unit mass was calculated using the following mathematical formula. Note that, in the following mathematical formula 9, I (A) is a constant current, m (g) is the total mass of the active materials of the two evaluation electrodes, and dV/dt (V/s) is the slope obtained by linear fitting the discharge curve between the voltage Vₘₐₓ at the start of discharge and ½Vₘₐₓ.

$$C = 4 I / ( m \cdot dV / dt ) \qquad [ mathematical formula 9 ]$$

As a result, the calculated capacitance per unit mass of the positive electrode active material was 76 F/g.

### (4) Measurement of Capacitance Per Unit Mass of Negative Electrode Active Material

As with the positive electrode, a laminate cell for evaluation was prepared also for the negative electrode, and the capacitance thereof was measured. Specifically, two evaluation electrodes with a size of 3.0 cm×3.0 cm were cut out from the positive electrode prepared by the method described above, and a metal lithium foil with a size of 3.0 cm×3.0 cm and a thickness of 100 μm as a counter electrode and a microporous membrane made of polypropylene (PP) with a thickness of 50 μm as a separator were laminated on these two electrodes, to fabricate a half cell. At that time, a metallic lithium foil was used as the reference electrode.

The electrolyte was prepared by dissolving lithium hexafluorophosphate (LiPF₆) to a concentration of 1 mol/L into a solvent that was a mixture of ethylene carbonate (EC) and diethyl carbonate (DEC) at a volume ratio of 1:1. The charging current density was set to 50 mA/g, and lithium ions were charged at a capacitance of 500 mAh/g based on the mass of the negative electrode active material, and then discharged to 3 V at 50 mA/g. The capacitance per unit mass of the negative electrode active material was determined from the discharge time required for the potential to change by 0.2 V with respect to the potential of the negative electrode 1 minute after the start of discharge. As a result, the calculated capacitance per unit mass of the negative electrode was 4000 F/g.

### (5) Preparation of Lithium Ion Capacitor Cell

Next, the positive electrode and negative electrode prepared by the method described above were each cut into a size of 3.0 cm×3.0 cm, and laminated with a separator interposed therebetween. After drying at 120° C. for 12 hours, two pieces of separators were placed at the top and bottom, and the four sides were fixed with tape. Furthermore, one sheet of 21 μm thick lithium metal foil crimped onto a 21 μm thick copper current collector (mesh-like copper plate) was placed on the outermost side of the electrode laminated unit so as to face the positive electrode, thereby obtaining an electrode laminated unit.

In this electrode laminated unit, an aluminum positive terminal was ultrasonically welded to the terminal welding part of the positive electrode current collector, and a nickel negative terminal was ultrasonically welded to the terminal welding part of the copper lath to which the negative electrode current collector and lithium metal foil were crimped. With the end of the electrode terminal drawn out from the exterior laminate film, one side of the exterior laminate film on the terminal side and the other two sides were heat-fused, and then the electrolyte was vacuum-impregnated. The electrolyte used is an electrolyte prepared by dissolving lithium hexafluorophosphate (LiPF₆) to a concentration of 1 mol/L into a solvent that is a mixture of ethylene carbonate (EC) and diethyl carbonate (DEC) at a volume ratio of 1:1. Finally, the remaining one side was heat-fused under reduced pressure and vacuum-sealed to form a lithium ion capacitor cell of this example.

### (6) Evaluation of Characteristics of Lithium Ion Capacitor Cell

First, the lithium ion capacitor cell No. 1 prepared using the method described above (hereinafter simply referred to as “cell”) was left for 14 days. Thereafter, the cell voltage was measured and found to be 2.7 V, so it was determined that the lithium ions had been intercalated (pre-doping had been completed). Next, the cell was charged with a constant current of 1 mA until the cell voltage reached 3.8 V, and was discharged with a constant current of 1 mA until the cell voltage reached 2.2 V. The initial capacitance was evaluated by performing this 3.8 V to 2.8 V cycle.

Thereafter, measurement was performed for 50 hours at an ambient temperature of 25° C. and a cell voltage of 3.5 V applied, for evaluation of leakage current. By simulation based on these data, the capacitance and capacitance retention rate after elapsing 2000 hours were determined. As a result, the leakage current at a cell voltage of 3.5 V was 10.0 μA, the initial capacitance was 241 mF, the capacitance after elapsing 2000 hours was 239 mF, and the capacity retention rate was 99.2%.

### Example 2

A lithium ion capacitor cell of No. 2 was prepared in the same manner and under the same conditions as in Example 1, except that the size was reduced to 4.2 mm×3.2 mm. The mass of the positive electrode active material was 0.008 g, the mass of the negative electrode active material was 0.172 g, and the mass ratio of these was 21.4, the same as in Example 1. In this lithium ion capacitor cell, the capacitance per unit mass is naturally the same as in Example 1.

The obtained lithium ion capacitor cell No. 2 was evaluated in the same manner as in Example 1. However, the charging/discharging current was changed from a constant current of 1 mA to 0.1 mA. As a result, the leakage current at a cell voltage of 3.5 V was 0.2 μA, the initial capacitance was 3.70 mF, the capacitance after elapsing 2000 hours was 3.67 mF, and the capacity retention rate was 99.2%.

### Example 3

A lithium ion capacitor cell No. 3 was prepared in the same manner and under the same conditions as in Example 1, except that the thickness of the positive electrode active material was reduced to 4 μm and the total thickness of the positive electrode including the current collector was changed to 35 μm. The mass of the positive electrode active material was 0.14 g, the mass of the negative electrode active material was 8.76 g, and the mass ratio of these was 62.6, the same as in Example 1. Note that the capacitance per unit mass depends only on the properties of the material and remains the same even if the thickness of the electrode is changed, so the capacitance per unit mass is the same as in Example 1.

As a result of evaluating the obtained lithium ion capacitor cell No. 3 using the same method and conditions as in Example 1, the leakage current at a cell voltage of 3.5 V was 8.0 μA, the initial capacitance was 79.0 mF, and the capacitance after elapsing 2000 hours was 78.5 mF, and the capacity retention rate was 99.4%.

As described above, the capacitance of the entire cell is the capacitance obtained by connecting the capacitance of the positive electrode and the capacitance of the negative electrode in series. In the lithium ion capacitor cell No. 3, the mass of the negative electrode active material is 62.6 times as large as that of the positive electrode, and the negative electrode capacity is large, so the series capacity largely depends on the positive electrode capacity. Since the thickness of the positive electrode active material was reduced to ⅓ of the lithium ion capacitor cell No. 1, the positive electrode capacity was also reduced to ⅓, and the capacitance of the entire cell was also reduced to approximately ⅓. Although this goes against increasing capacity, it is suitable for application to systems that require charging and discharging minute charges, such as energy harvesting.

### Example 4

A lithium ion capacitor cell No. 4 was prepared in the same manner and under the same conditions as in Example 3, except that the size was reduced to 4.2 mm×3.2 mm. In this lithium ion capacitor cell, the capacitance per unit mass was naturally the same as that of the cell No. 3, and the mass ratio of the positive electrode active material to the negative electrode active material was also 62.6, the same as in the cell No. 3.

The obtained lithium ion capacitor cell No. 4 was evaluated in the same manner and under the same conditions as in Example 2, that is, using a charging/discharging current of 0.1 mA. As a result, the leakage current at a cell voltage of 3.5 V was 0.1 μA, the initial capacitance was 1.10 mF, the capacitance after elapsing 2000 hours was 1.09 mF, and the capacity retention rate was 99.1%.

### Example 5

A positive electrode was prepared in the same manner and under the same conditions as in Example 1, except that a composite of carbon nano-tubes and graphene was used as the positive electrode active material instead of activated carbon powder. The capacitance per unit mass of the positive electrode active material was 150 mF/g. Further, the thickness of the positive electrode active material layer on one side was 8 μm, the total thickness of the positive electrode including the positive electrode current collector was 39 μm, and the mass of the positive electrode active material was 0.27 g.

The negative electrode was prepared in the same manner as in Example 1. The thickness of the negative electrode active material layer on one side was 101 μm, the total thickness of the negative electrode including the thickness of the negative electrode current collector was 122 μm, and the mass of the negative electrode active material was 8.76 g, and the mass ratio of the negative electrode active material to the positive electrode active material was 32.4. Note that the capacitance per unit mass of the negative electrode active material was 4000 F/g as in Examples 1 to 4.

A lithium ion capacitor cell No. 5 was prepared in the same manner and under the same conditions as in Example 1 using the above-described positive and negative electrodes, and evaluated in the same manner and under the same conditions as in Example 1, and as a result, the leakage current at a cell voltage of 3.5 V was 11.0 μA, the initial capacitance was 321 mF, the capacitance after elapsing 2000 hours was 316 mF, and the capacity retention rate was 98.4%.

Since this lithium ion capacitor cell No. 5 used a composite of carbon nano-tubes and graphene as the positive electrode active material, the capacitance per unit mass of the positive electrode active material was 1.97 times that of cell No. 1. Further, even when the thickness of the positive electrode active material was reduced from 12 μm to 8 μm, the capacitance of the entire cell increased 1.33 times from 241 mF to 320 mF. This revealed that by using a composite of carbon nano-tubes and graphene as the positive electrode active material, a lithium ion capacitor cell with the required capacitance can also be made smaller.

### Example 6

A positive electrode and a negative electrode were prepared in the same manner and under the same conditions as in Example 5. The mass of the positive electrode active material was 0.005 g, the mass of the negative electrode active material was 0.172 g, and the mass ratio was 32.4, the same as in Example 5. Note that the capacitance per unit mass of each electrode active material is naturally the same as in Example 5.

A lithium ion capacitor cell No. 6 was prepared in the same manner and under the same conditions as in Example 5, except that the above-described positive and negative electrodes were used and the size was reduced to 4.2 mm×3.2 mm. The characteristics of this lithium ion capacitor cell were evaluated in the same manner and under the same conditions as in Example 2, that is, using a charging/discharging current of 0.1 mA. As a result, the leakage current at a cell voltage of 3.5 V was 0.3 μA, the initial capacitance was 4.80 mF, the capacitance after elapsing 2000 hours was 4.72 mF, and the capacity retention rate was 98.3%.

As a result, it was found that even if a composite of carbon nano-tubes and graphene is used as the positive electrode active material, there is no problem in cell miniaturization, and when making a lithium ion capacitor cell with the required capacitance smaller, it is possible to reduce the area in addition to making the cathode active material thinner.

### Example 7

A positive electrode and a negative electrode were prepared in the same manner and under the same conditions as in Example 1, except that the thickness of the negative electrode active material was 26 μm, and the total thickness of the negative electrode including the negative electrode current collector was 47 μm. The mass of the negative electrode active material was 2.23 g, and the mass ratio to the positive electrode active material was 5.4. Note that the capacitance per unit mass of each electrode active material is the same as that of the electrodes in Examples 1 to 4.

A lithium ion capacitor cell No. 7 was prepared in the same manner and under the same conditions as in Example 1, except that the above-described positive and negative electrodes were used and the thickness of the metal lithium foil to be attached was changed to 5 μm. As a result, the leakage current at a cell voltage of 3.5 V was 9.8 μA, the initial capacitance was 240 mF, the capacitance after elapsing 2000 hours was 236 mF, and the capacity retention rate was 98.3%.

### Example 8

A positive electrode and a negative electrode were prepared in the same manner and under the same conditions as in Example 1 described above, except that the thickness of the negative electrode active material was 167 μm and the total thickness of the negative electrode including the negative electrode current collector was 188 μm. The mass of the negative electrode active material was 14.5 g, and the mass ratio to the positive electrode active material was 35.4. Note that the capacitance per unit mass of each electrode active material is the same as that of the electrodes in Examples 1 to 4.

A lithium ion capacitor cell No. 8 was prepared in the same manner and under the same conditions as in Example 1 and Example 7, except that the above-described positive and negative electrodes were used and the thickness of the metal lithium foil to be attached was changed to 32 μm. As a result, the leakage current at a cell voltage of 3.5 V was 9.0 μA, the initial capacitance was 241 mF, the capacitance after elapsing 2000 hours was 239 mF, and the capacity retention rate was 99.2%.

### Example 9

A positive electrode and a negative electrode were prepared in the same manner and under the same conditions as in Example 1 described above, except that the thickness of the positive electrode active material was 12 μm and the total thickness of the positive electrode including the positive electrode current collector was 55 μm. The mass of the positive electrode active material was 0.82 g, the mass of the negative electrode active material was 2.23 g, and the mass ratio of the negative electrode active material to the positive electrode active material was 2.7. Note that the capacitance per unit mass of each electrode active material is the same as that of the electrodes in Examples 1 to 4.

A lithium ion capacitor cell No. 9 was prepared in the same manner and under the same conditions as in Example 1, except that the above-described positive and negative electrodes were used and the thickness of the metal lithium foil to be attached was changed to 5 μm. This lithium ion capacitor cell had a leakage current of 9.6 μA at a cell voltage of 3.5 V, an initial capacitance of 475 mF, a capacitance of 470 mF after elapsing 2000 hours, and a capacity retention rate of 98.9%.

### Example 10

A positive electrode was prepared in the same manner and under the same conditions as in Example 1. The negative electrode was prepared using graphite instead of carbonaceous electrode material (hard carbon) powder. The median diameter (D50) of the graphite used in the negative electrode was 4.3 μm, the thickness of the negative electrode active material was 152 μm, and the total thickness of the negative electrode including the thickness of the negative electrode current collector was 173 μm. Further, the mass of the negative electrode active material was 15.1 g, and the mass ratio to the positive electrode active material was 36.8.

When the capacitance per unit mass of the negative electrode active material was measured in the same manner as in Example 1, it was 15263 F/g. Note that the capacitance per unit mass of the positive electrode active material was 76 F/g, the same as in Examples 1 to 4.

A lithium ion capacitor cell No. 10 was prepared using the above-described positive and negative electrodes. At that time, an electrode laminated unit was prepared in which the thickness of the metal lithium foil to be attached was changed to 27 μm, and one sheet of the metal lithium foil crimped onto a 21 μm thick copper lath (mesh-like copper plate) was placed at the outermost part of the electrode laminated unit so as to face the positive electrode. This lithium ion capacitor cell No. 10 was evaluated in the same manner as in Example 1, and as a result, the leakage current at a cell voltage of 3.5 V was 8.8 μA, the initial capacitance was 243 mF, the capacitance after elapsing 2000 hours was 242 mF, and the capacity retention rate was 99.6%.

### Example 11

A positive electrode was prepared in the same manner and under the same conditions as in Example 1. The mass of the positive electrode active material was 0.081 g, the mass of the negative electrode active material was 2.23 g, and the mass ratio of the negative electrode active material to the positive electrode active material was 21.4 as in Example 1. Note that the capacitance per unit mass of each electrode active material is the same as that of the electrode in Example 1.

Using the above-mentioned positive and negative electrodes, and using a coin-shaped exterior body instead of a laminate film, a lithium ion capacitor cell No. 11 was prepared. A C2032 coin-shaped cell was used for the exterior body. Specifically, a positive electrode and a negative electrode were each cut into a circular shape with a diameter of 15 mm, and then laminated with a separator interposed therebetween, and further, circular metal lithium with a thickness of 21 μm and a diameter of 15 mm was then laminated on the positive electrode, which was placed inside the cell, and the electrolyte was vacuum-impregnated, and then, sealed, to obtain a coin-shaped capacitor cell.

At that time, the electrolyte used was lithium hexafluorophosphate (LiPF6) with a concentration of 1 mol/L and dissolved into a solvent that was a mixture of ethylene carbonate (EC) and diethyl carbonate (DEC) at a volume ratio of 1:1.

When the characteristics of the coin-shaped capacitor cell (lithium ion capacitor cell No. 11) assembled using the method described above were evaluated in the same manner as in Example 1, the leakage current at a cell voltage of 3.5 V was 3.0 ρA, the initial capacitance was 34.0 mF, the capacitance after elapsing 2000 hours was 33.7 mF, and the capacity retention rate was 99.1%.

### Comparative Example 1

A positive electrode and a negative electrode were prepared in the same manner and under the same conditions as in Example 1, except that YP-50 activated carbon powder with a specific surface area of 1600 m²/g and a median diameter (D50) of 5 μm was used as the positive electrode active material. At that time, the thickness of the positive electrode active material on one side was 82 μm, and the total thickness of the positive electrode including the thickness of the positive electrode current collector was 113 μm.

The mass of the positive electrode active material was 4.9 g, the mass of the negative electrode active material was 8.76 g, and the mass ratio of the negative electrode active material to the positive electrode active material was 1.8. Further, when the capacitance per unit mass of the positive electrode active material was measured in the same manner as in Example 1, it was 100 F/g. Note that the capacitance per unit mass of the negative electrode active material is 4000 F/g as in Examples 1 to 4.

Using the above-described positive and negative electrodes, a lithium ion capacitor cell No. 12 was prepared and the characteristics thereof were evaluated in the same manner as in Example 1. As a result, the leakage current at a cell voltage of 3.5 V was 25 μA, the initial capacitance was 3604 mF, the capacitance after elapsing 2000 hours was 3273 mF, and the capacity retention rate was 90.8%.

### Comparative Example 2

A positive electrode and a negative electrode were prepared in the same manner and under the same conditions as in Example 7. Similarly to Example 7, the mass of the positive electrode active material was 0.41 g, the mass of the negative electrode active material was 2.23 g, and the mass ratio of the negative electrode active material to the positive electrode active material was 5.4. Note that the capacitance per unit mass of each electrode active material is the same as that of the electrodes in Examples 1 to 4.

Using the above-described positive and negative electrodes, a lithium ion capacitor cell No. 13 was prepared. At that time, an electrode laminated unit was prepared in which the thickness of the metal lithium foil to be attached was changed to 15 μm, and one sheet of the metal lithium foil crimped onto a 21 μm thick copper lath (mesh-like copper plate) was placed on the outermost side of the electrode laminated unit so as to face the positive electrode. This lithium ion capacitor cell No. 13 was evaluated in the same manner as in Example 1, and as a result, the leakage current at a cell voltage of 3.5 V was 16 μA, the initial capacitance was 240 mF, the capacitance after elapsing 2000 hours was 208 mF, and the capacity retention rate was 86.7%. The above results are summarized in Table 1 below. In Table 1 below, “BF” indicates activated carbon, “CNT/G” indicates a composite of carbon nano-tubes and graphene, and “LF” indicates a laminate film.

TABLE 1

| | Positive electrode active material | | | | | | | | |
|---|---|---|---|---|---|---|---|---|---|
| | | Median | | | | Negative electrode active material | | | |
| | | diameter | Capacitance | Thickness | Mass | | Capacitance | Thickness | Mass |
| Sample No. | Material | (D50) (μm) | (mF/g) | (μm) | (g) | Material | (mF/g) | (μm) | (g) |
| 1 | BF | 1.4 | 76 | 12 | 0.41 | BF | 4000 | 101 | 8.76 |
| 2 | BF | 1.4 | 76 | 12 | 0.008 | BF | 4000 | 101 | 0.172 |
| 3 | BF | 1.4 | 76 | 4 | 0.14 | BF | 4000 | 101 | 8.76 |
| 4 | BF | 1.4 | 76 | 4 | 0.003 | BF | 4000 | 101 | 0.172 |
| 5 | CNT/G | — | 150 | 8 | 0.27 | BF | 4000 | 101 | 8.76 |
| 6 | CNT/G | — | 150 | 8 | 0.005 | BF | 4000 | 101 | 0.172 |
| 7 | BF | 1.4 | 76 | 12 | 0.41 | BF | 4000 | 26 | 2.23 |
| 8 | BF | 1.4 | 76 | 12 | 0.41 | BF | 4000 | 167 | 14.5 |
| 9 | BF | 1.4 | 76 | 24 | 0.82 | BF | 4000 | 26 | 2.23 |
| 10 | BF | 1.4 | 76 | 12 | 0.41 | graphite | 15263 | 152 | 15.1 |
| 11 | BF | 1.4 | 76 | 12 | 0.081 | BF | 4000 | 101 | 1.72 |
| 12 | YP-50 | 5.0 | 100 | 82 | 4.9 | BF | 4000 | 101 | 8.76 |
| 13 | BF | 1.4 | 76 | 12 | 0.41 | BF | 4000 | 26 | 2.23 |

| | | | | Active | | | | |
|---|---|---|---|---|---|---|---|---|
| | | | | material | | | | |
| | | | | mass ratio | Capacitance | | | |
| | | | | (negative | | After | | Leakage |
| | Electrode | Li | | electrode/ | | elapsed | | current |
| | Dimension | thickness | Exterior | positive | Initial | time | Retention | @3.5 V |
| Sample No. | (mm²) | (μm) | body | electrode) | (mF) | (mF) | (%) | (μA) |
| 1 | 30 × 30 | 21 | LF | 21.4 | 241 | 239 | 99.2 | 10.0 |
| 2 | 4.2 × 3.2 | 21 | LF | 21.4 | 3.70 | 3.67 | 99.2 | 0.2 |
| 3 | 30 × 30 | 21 | LF | 62.6 | 79.0 | 78.5 | 99.4 | 8.0 |
| 4 | 4.2 × 3.2 | 21 | LF | 62.6 | 1.10 | 1.09 | 99.1 | 0.1 |
| 5 | 30 × 30 | 21 | LF | 32.4 | 321 | 316 | 98.4 | 11 |
| 6 | 4.2 × 3.2 | 21 | LF | 32.4 | 4.80 | 4.72 | 98.3 | 0.3 |
| 7 | 30 × 30 | 5 | LF | 5.4 | 240 | 236 | 98.3 | 9.8 |
| 8 | 30 × 30 | 32 | LF | 35.4 | 241 | 239 | 99.2 | 9.0 |
| 9 | 30 × 30 | 5 | LF | 2.7 | 475 | 470 | 98.9 | 9.6 |
| 10 | 30 × 30 | 27 | LF | 36.8 | 243 | 242 | 99.6 | 8.8 |
| 11 | φ1.5 | 21 | coin | 21.4 | 34.0 | 33.7 | 99.1 | 3.0 |
| 12 | 30 × 30 | 21 | LF | 1.8 | 3604 | 3273 | 90.8 | 25 |
| 13 | 30 × 30 | 15 | LF | 5.4 | 240 | 208 | 86.7 | 16.0 |

From a comparison between Example 1 (No. 1) and Example 2 (No. 2), and between Example 3 (No. 3) and Example 4 (No. 4), shown in Table 1 above, it was confirmed that the leakage current could be suppressed to a smaller level though the capacitance of the lithium ion capacitor cell was reduced to approximately ⅓ by reducing only the thickness of the positive electrode active material from 12 μm to 4 μm (the total thickness of the positive electrode including the current collector from 43 μm to 35 μm) without changing the thickness of the negative electrode.

From a comparison between Example 1 (No. 1) and Example 2 (No. 2) and between Example 5 (No. 5) and Example 6 (No. 6), it was confirmed that even if the size of the electrode was reduced from 30 mm×30 mm to 4.2 mm×3.2 mm, the capacitance retention rate and leakage current were not affected. In addition, regarding the effect of changing the positive electrode active material from activated carbon powder to a composite of carbon nano-tubes and graphene, the capacitance per unit mass of the positive electrode active material increased from 76 F/g to 150 F/g, and the capacitance of the lithium ion capacitor cell also increased significantly.

On the other hand, the deterioration of the retention rate was limited, from 99.2% to 98.2-98.3%. Similarly, the leakage current deteriorated from 10.0 μA in Example 1 (No. 1) and 0.2 μA in Example 2 (No. 2) to 11.0 μA in Example 5 (No. 5) and 0.3 μA in Example 6 (No. 6), which was limited.

In Example 7 (No. 7) and Example 8 (No. 8), the thickness of the negative electrode was changed compared to Example 1 (No. 1), and in Example 7 (No. 7), it is thinner, and in Example 8 (No. 8), it is thicker. All of these lithium ion capacitors had a retention rate of 98% or more and a leakage current of 10 μA or less, showing good characteristics. However, from Comparative Example 2 (No. 13), it was confirmed that the thickness of the metal lithium foil needs to be appropriately adjusted so as not to cause residues when pre-doped into the negative electrode.

Example 9 (No. 9) is an example in which the thickness of the positive electrode was changed compared to Example 7 (No. 7), and compared to Example 7 (No. 7), the positive electrode was thicker and the negative electrode is thinner, and thus, the mass ratio of the negative electrode active material to the positive electrode active material is as small as 2.7. In Example 9 (No. 9), the capacitance was increased due to the increased mass of the positive electrode active material, but as described above, characteristics of the retention rate and leakage current were within a good range.

In Example 10 (No. 10), the negative electrode active material was changed to graphite, and the capacitance of the negative electrode active material increased significantly, but the increase in the capacitance of the lithium ion capacitor cell was slight, confirming contribution to improving the retention rate and reducing leakage current. From Example 11 (No. 11), it was confirmed that the configuration of the present invention exhibits good characteristics even when applied to a coin-shaped capacitor cell, regardless of the type of the exterior body.

On the other hand, in Comparative Example 1 (No. 12) in which the mass ratio of the negative electrode active material to the positive electrode active material was 1.8, the capacity retention rate decreased significantly and the leakage current increased, and thus, it was not suitable for the electricity storage device used in combination with energy harvesting. In addition, in Comparative Example 1 (No. 12), since a positive electrode active material with a median diameter (D50) of 5 μm was used, the capacitance of the lithium ion capacitor cell increased by more than 10 times, but the capacity retention rate was significantly deteriorated.

Further, in Comparative Example 2 (No. 13) in which the thickness of the lithium metal foil for pre-doping was changed to 15 μm, the capacitance retention rate deteriorated to 86.7% and the leakage current deteriorated to 16.0 ρA. In this lithium ion capacitor cell, problems such as lithium precipitation occurred, namely, it is believed that the negative electrode was not properly pre-doped with lithium ions. From this result, it is considered that the thickness of metallic lithium needs to be adjusted to be appropriately thin according to the thickness of the negative electrode.

From the above results, it was confirmed that according to the present invention, it is possible to realize a lithium ion capacitor for energy harvesting that has minute self-discharge and whose capacitance almost does not decrease even after repeated charging and discharging.

1. A lithium ion capacitor for energy harvesting, comprising
a positive electrode containing a positive electrode active material that reversibly adsorbs and desorbs lithium ions and anions;
a negative electrode containing a negative electrode active material that reversibly occludes and releases lithium ions; and
an electrolyte solution containing a lithium salt and an aprotic organic solvent and in contact with the positive electrode and the negative electrode;
wherein
lithium ions are pre-doped in advance in the negative electrode, and
the mass of the negative electrode active material contained in the negative electrode is more than twice the mass of the positive electrode active material contained in the positive electrode.

2. The lithium ion capacitor for energy harvesting according to claim 1, wherein the positive electrode active material is a composite of graphene and carbon nano-tubes.

3. The lithium ion capacitor for energy harvesting according to claim 1, wherein the positive electrode active material has a median diameter (D50) of 5 μm or less.

4. The lithium ion capacitor for energy harvesting according to claim 1, wherein metallic lithium is arranged as a supply source of the lithium ions to the negative electrode.

5. The lithium ion capacitor for energy harvesting according to claim 1, which is encapsulated in an exterior body made of a metal foil laminate film.

6. The lithium ion capacitor for energy harvesting according to claim 1, which is encapsulated in a coin-shaped exterior body.

7. The lithium ion capacitor for energy harvesting according to claim 2,
wherein the positive electrode active material has a median diameter (D50) of 5 μm or less.

8. The lithium ion capacitor for energy harvesting according to claim 2, wherein metallic lithium is arranged as a supply source of the lithium ions to the negative electrode.
